(19) United States
(12) Patent Application Publication
(10) Pub. No.: US 2003/0100316 A1
(43) Pub. Date: May 29, 2003

(54) Map information display system

(75) Inventor: Satoshi Odamura, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/300,754

(22) Filed: Nov. 21, 2002

(30) Foreign Application Priority Data
Nov. 26, 2001 (JP) 2001-359258

(51) Int. Cl. H04Q 7/20; G06F 15/16; G06F 12/10; G06F 9/34; G01S 1/00

(52) U.S. Cl. 455/456; 455/566; 455/414; 709/219; 711/208; 711/213; 342/357.09; 342/357.1; 342/357.13

(57) ABSTRACT

A portable radio terminal includes a GPS signal processor for determining the position of the portable radio terminal, and requests a system server to transmit map image data and landmark data in the vicinity of the portable radio terminal. The system server transmits the map image data and landmark data separately to allow the display unit of the portable radio terminal to represent desired landmarks overlapped with the map image on the display unit.

### BACKGROUND OF THE INVENTION

(a) Field of the Invention

The present invention relates to a map information display system and, more particularly, to a map information display system for use in portable radio terminals such as personal digital assistant, personal handyphone and cellular phone. The present invention also relates to a personal radio terminal receiving map information in the map information display system, and a method for displaying map information on the display unit of such a personal radio terminal.

(b) Description of the Related Art

A map information display system provides particular map information to a portable radio terminal, the map information including the map image of the position at which the portable radio terminal resides and the vicinity thereof. The map information display system generally provides the map information including landmarks such as banks and convenience stores for assuring the user to know his location and the direction of the travel or his destination.

In the mean time, most portable radio terminals such as personal digital assistant and cellular phone have a function for determining the own positions by using a GPS system. In such a portable radio terminal, the map image as well as the landmarks is displayed on a display unit of the portable radio terminal, the landmarks being customized for the user.

It is to be noted, however, that the portable radio terminal has a small display unit and there is a difficulty to differentiate the map image from the landmarks if the landmarks are overlapped with the map image on the small display unit. In particular, such a situation applies if a large number of objects to be displayed as landmarks are located in the case of an urban area, for example, and if a relatively larger area is displayed on the display unit in a larger contraction scale.

It may considered that the portable radio terminal has therein a memory device for storing information of the map image and landmarks in respective layers, wherein the desired landmarks are read out from the memory device and displayed on the display unit together with the map image only when the user specifies the species of the landmarks, such as banks or convenience stores. However, in a small-scale portable radio terminal such as a cellular phone, wherein the memory device has a limited capacity, it is difficult to store the large-volume map image file in the memory device beforehand or to download the map image data and the landmark data in respective layers through the network and store these data in the memory device.

In the above circumstances, it is usual that the map image file including the landmark information are prepared by a server of a map information supply system, wherein the portable radio terminal downloads the map image file from the map information supply system and represents the map image file on the display unit in a bitmap format or graphics interchange format.

If the user wishes to change or add the species of the landmarks after the map image file including the landmarks is displayed on the display unit, the map image file including only the desired landmarks should be downloaded. This downloading is involved with a large amount of data, thereby increasing the load on the networks upon the downloading and increasing the communication costs for the portable radio terminal.

### SUMMARY OF THE INVENTION

It is therefore an object of the present invention to provide a map information display system, which is capable of transmitting map image file and landmark data at a lower cost and a lower load for the network.

It is another object of the present invention to provide such a portable radio terminal and a method for displaying the map information in the map information display system.

The present invention provides, in one aspect thereof, a map information display system comprising a plurality of portable radio terminals each including a display unit, and at least one system server connected to the portable radio terminals via a network and storing therein map image data and landmark data, wherein each the portable radio terminal has functions for transmitting information of a position of the portable radio terminal to the system server, receiving part of the landmark data and part of the map image data corresponding to the position of the portable radio terminal from the system server, and allowing the display unit to selectively represent thereon icons of landmarks specified by the part of the landmark data overlapped with a map image specified by the part of the map image data.

The present invention also provide, in another aspect thereof, a portable radio terminal comprising: a communication block for receiving part of map image data and part of landmark data via a network from a server connected to the communication block, the part of map image data and the part of landmark data corresponding to a position of the portable radio terminal; a display unit for representing a map image specified by the part of the map image data; and a control unit for controlling the display unit to selectively represent landmarks specified by the part of the landmark data, the landmarks being overlapped with the map image on the display unit.

The present invention also provides, in another aspect thereof, a method for supplying map information to a portable radio terminal comprising: storing separately map image data and landmark data, the landmark data including information of a plurality of species of landmarks, coordinates of each of the landmarks, and a name of each of the landmarks: specifying part of the map image data and part of the landmark data based information of a position of the portable radio terminal received therefrom; and transmitting the specified part of the map image data and the specified part of the landmark data in a format to allow a display unit of the portable radio terminal to selectively display icons of landmarks specified by the part of the landmark data while being overlapped with a map image specified by the part of the map image data.

In accordance with the map image display system, the portable radio terminal and the method of the present invention, since the icon of the landmarks specified by part of the landmark data are selectively displayed on the display unit while being overlapped with the map image specified by part of the map image data on the display unit, and the part of the landmark data and the part of the map image data are retrieved from respective data files, the portable radio terminal can represent the landmarks overlapped with the map image, and also can remove the landmarks from the map image or change the landmarks independently of the map image. In other words, the portable radio terminal can treat the landmark data separately from the map image data in the own terminal, and accordingly, can receive the landmark data separately from the map image data at a lower communication cost and with a lower load for the network.

The above and other objects, features and advantages of the present invention will be more apparent from the following description, referring to the accompanying drawings.

### BRIEF DESCRIPTION OF THE DRAWINGS

FIG. 1 is a block diagram of a map information display system according to an embodiment of the present invention.

FIG. 2A is a block diagram of the portable radio terminal shown in FIG. 1, and FIG. 2B is a schematic front view thereof.

FIG. 3 is a flowchart of the process performed in the map information display system of FIG. 1.

FIGS. 4A, 4B and 4C are examples of the map information represented on the display unit of the portable radio terminal of FIGS. 2A and 2B.

FIG. 5 is a front view of the keyboard of the portable radio terminal of FIGS. 2A and 2B, showing exemplified allocation of functions to the keyboard.

FIG. 6 is exemplified contents of the map information file transmitted from the server of the map information display system of the embodiment.

FIG. 7 is other exemplified contents of the map information file transmitted from the server of the map information display system of the embodiment.

FIGS. 8A, 8B and 8C are examples of the map information represented on the display unit of the portable radio terminal of FIGS. 2A and 2B.

FIG. 9 is other exemplified contents of the map information file transmitted from the server of the map information display system of the embodiment.

### PREFERRED EMBODIMENTS OF THE INVENTION

Now, the present invention is more specifically described with reference to accompanying drawings, wherein similar constituent elements are designated by similar reference numerals.

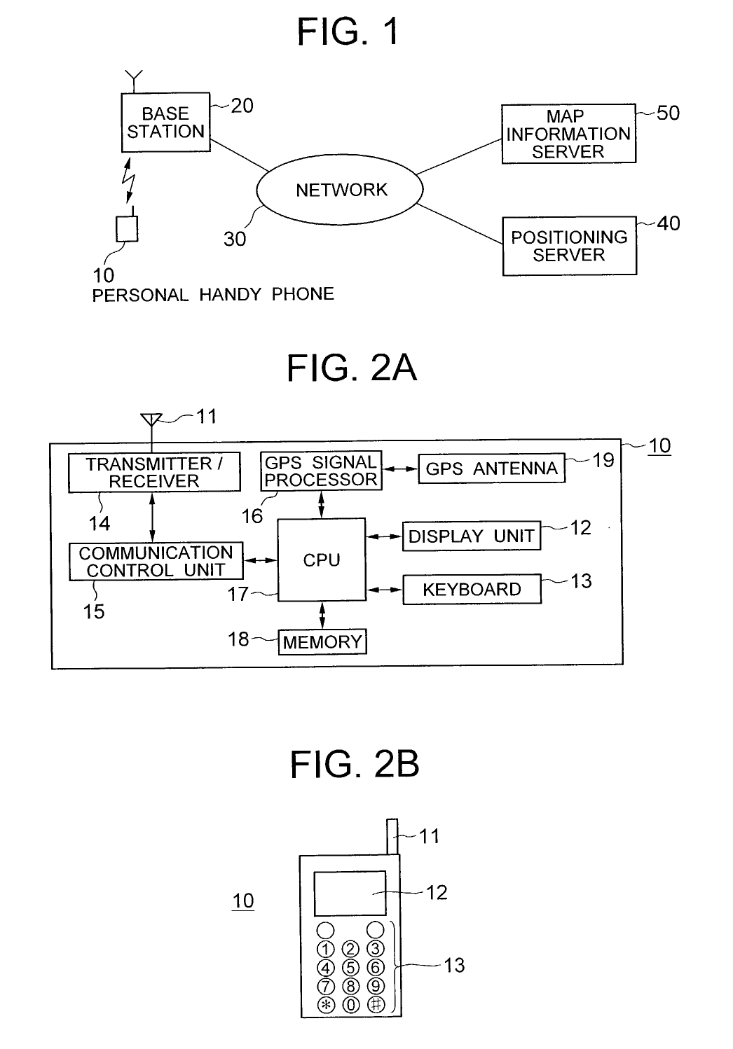

Referring to FIG. 1, a map information display system according to an embodiment of the present invention includes a positional information server 40, a map information server 50, and a plurality of radio base stations 20, which are connected by a network 30 such as internet. A plurality of portable radio terminals 10 are communicated to radio base stations 20 depending on the position of the portable data terminals 10 via a radio network. Each portable radio terminal 10 includes a global positioning system (GPS) function for positioning the own terminal 10 by using a GPS system. A plurality of positional information servers 40 and/or a plurality of map information server 50 having different functions or operating on different software may be provided as a combined system server in the map information display system.

The portable radio terminal 10 performs communication with the positional information server 40 via the radio network and the network 30 on higher level protocols for registration of the positional information of the own terminal 10 and acquisition of the positional information of another terminal 10. The portable radio terminal 10 also receives part of the map information around the own terminal 10 or around the another terminal, for which the positional information is acquired by using the GPS function, from the map information server 50 via the network 30.

The positional information server 40 receives the positional information of the portable radio terminal 10 therefrom, receives a map image file and landmark data from the map information server 50, and transmits the map image file and the landmark data to the portable radio terminal 10 via the network 30 and the radio base station 20.

The map information server 50 stores therein the map image data and the landmark data, and supplies part of the map image data and part of the landmark data specified by the positional information server 40.

Referring to FIG. 2A, the portable radio terminal 10 shown in FIG. 1 includes a communication antenna 1, a transceiver 14, a communication control unit 15, a GPS antenna 19, a GPS signal processor 16, a memory 18, a display unit 12, a keyboard 13, and a CPU 17.

The communication antenna 11 transmits and receives data to and from the radio base stations 20 via the radio network. The transceiver 14 modulates the signals to be transmitted by the communication antenna 11, and demodulates the signals received by the communication antenna 11. The communication control unit 15 controls the communication performed between the portable radio terminal 10 and the radio base station 20 via the communication antenna 11 and the transceiver 14.

The GPS antenna 19 receives GPS signals from GPS satellites (not shown), and the GPS signal processor 16 operates for processing of the GPS signals received via the GPS antenna 19. The memory 18 temporarily stores therein signals received via the communication antenna 11 and the GPS antenna 19, and also stores software etc. for the CPU 17. The display unit or LCD unit 12 represents images on the screen thereof based on the map image data as well as the landmark data. The CPU 17 stores the GPS signals received via the GPS antenna 19 in the memory 18, receives signals such as map image data and landmark data received via the communication antenna 11 and demodulated by the transceiver 14, and delivers to the communication control unit 15 a control signal corresponding to the keypad depressed in the keyboard 13.

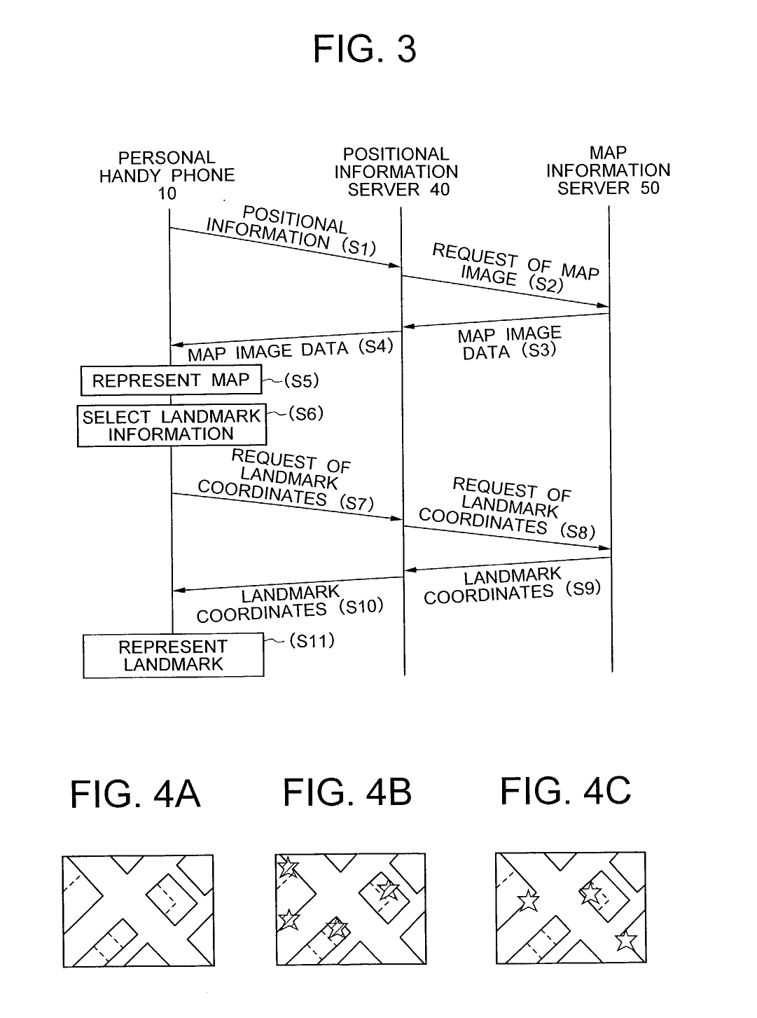

Referring to FIG. 3, there is shown an example of the signal communication process in the map information display system of FIG. 1. First, after the user operates the keyboard 13 for detecting the own position, the CPU 17 controls the GPS signal processor 16 to operate for signal processing of the GPS signals received via the GPS antenna 19, whereby the positional information of the radio terminal 10 including latitudinal data and longitudinal data is obtained in the GPS signal processor 16.

The positional information thus obtained is delivered from the GPS signal processor 16 to the CPU 17, which stores the positional information in the memory 18 and allows the communication control unit 15 to transmit the positional information via the communication antenna 11 after modulation by the transceiver 14.

The positional information transmitted through the communication antenna 11 is received by the positional information server 40 via the radio base station 20 and the network 30 (step S1).

The positional information server 40 registers the received positional information, and requests the map information server 50 to transmit part of the map image data corresponding to the positional information, i.e., map image data around the portable radio terminal 10 (step S2).

The map information server 50 responds the request from the positional information server 40 to transmit a map image file, which is either bitmap or GIF image data, for example, to the positional information server 40 (step S3). The map image file is then transmitted to the portable radio terminal 10 through the positional information server 40, the network 30 and the radio base station 20 (step S4).

The map image file is received through the communication antenna 11, demodulated by the transceiver 14, and then displayed on the display unit 12 by the control of the CPU 17 (step S5). In the techniques for registration of the positional information of the portable radio terminal 10 in the map information server 50 and acquisition of the map image file by the map information server 50 from the positional information server 40, the positional information server 40 may use HTTP protocol to specify the positional information by URL, for example. This will be exemplified hereinafter in the stage of acquisition of the map image data. Deposition of data in the URL may be executed by using any of a variety of known techniques, which are not specifically described herein.

The URL used herein may be:

“http://www.mapserver.co.jp/map.cgi?Lat=35.XXXX&Lon=139. YYYY&Level=3”,

wherein “www.mapserver.co.jp” indicates the positional information server 40 or the map information server 50, “Lat”, “Lon”, and “Level” indicate latitudinal data, longitudinal data and the reduction scale of the map image, respectively.

Referring to FIG. 4A, the map image transmitted from the map information server 50 to the portable radio terminal 10 and initially represented on the display unit 12 includes no landmark, as shown in the figure.

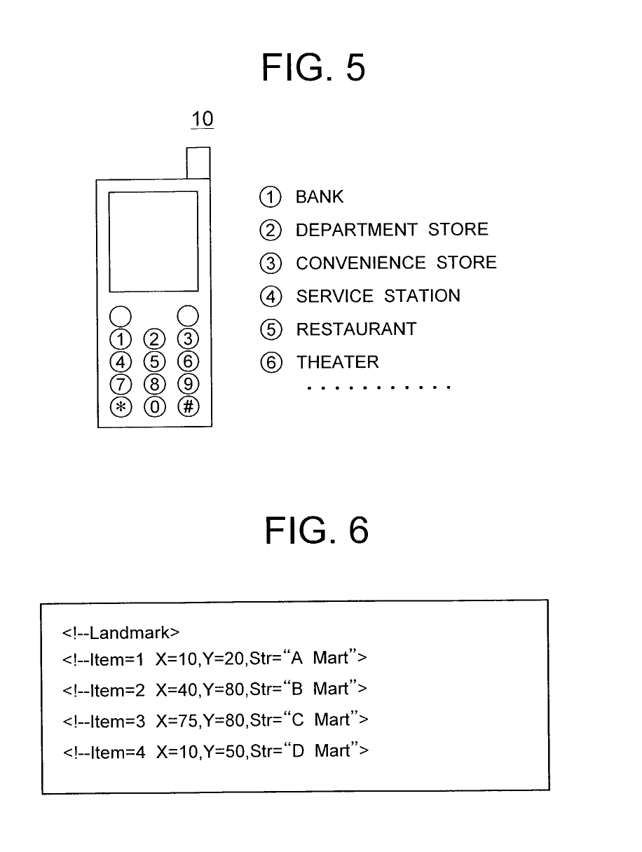

Then, the user specifies species of the landmarks, that the user wish to represent on the display unit, by using the keyboard 13 on the portable radio terminal 10 (step S6). Referring to FIG. 5, each keypad in the keyboard corresponds to one of the species of the landmarks when the map image is represented on the screen of the display unit 13. For example, numeral key “1” and “2” correspond to banks and department stores, respectively, as the species of the landmarks.

After the user depresses a keypad corresponding to the species of landmarks that the user wishes to observe on the display unit, the CPU 17 transmits a landmark request signal that requests the specified species of the landmarks via the communication control unit 15, transceiver 14 and communication antenna 11 to the positional information server 40 (step S7). The landmark request signal received by the positional information server 40 is further transmitted to the map information server 50 (step S8). The landmark request signal specifies the species of the landmarks by using the URL as follows:

“http://www.mapserver.co.jp/map.cgi?Lat=35.XXXX&Lon=139. YYYY&Level=3&LM=3”,

wherein “LM=3” specifies landmark of convenience stores as shown in FIG. 5.

The map information server 50 transmits a landmark file which includes information of the coordinates of the landmarks which are specified for the position and the scale level thereof (step S9), the landmark file being attached with a header which indicates that the subject file is a landmark file.

FIG. 6 shows an example of the landmark file transmitted from the map information server 50.

The landmark file shown in FIG. 6 uses a comment tag in a HTML format. In an alternative, the landmark file may use an extended tag of the HTML format, or may use a new protocol.

The first row of the landmark file includes the header which indicates that the subject file includes landmark information. The second and subsequent rows indicate the contents of the landmark file including the sequential numbers of the landmarks, and position and name thereof. In FIG. 5, it is shown that Item1 has coordinates of X=10 and Y=20 and the name of Item1 is “A Mart”.

The landmark file transmitted from the map information server 50 is received by the positional information server 40, which further transmits the same via the network 30 and the radio base station 20 to the portable radio terminal 10 (step S10).

After the portable radio terminal 10 receives the landmark file, the CPU 17 controls the display unit 12 to represent icons on the screen while being overlapped with the map image. The icons are represented at the position specified by the coordinates in the landmark file, thereby indicating the positions of the landmarks selected by the user on the portable radio terminal 10, as shown in FIG. 4B.

If the user further specifies another species of landmarks by using the keyboard 13, similar treatments are performed and the another species of landmarks can be represented on the display unit 12 instead of the previous landmarks, while being overlapped with the map image, as shown in FIG. 4C. In an alternative, the another species of landmarks may be overlapped with the previous landmarks and the map image.

As described above, the portable radio terminal 10 first receives the map image file from the map information server 50, and then receives the landmark file therefrom by selecting the species of landmarks. This enables the user to arbitrarily select, change, delete or add the landmarks in the map image, and thus the size of the file transmitted for the change, deletion or addition of the landmarks can be reduced for achieving a shorter transmission time. Thus, although the desired landmarks are represented together with the map image at a high speed, the load on the network, and thus the communication costs for the portable radio terminal 10 can be reduced.

It is to be noted that although the GPS signal is treated in the portable radio terminal 10 itself for obtaining the positional information thereof, the positional information may be obtained by other techniques, such as using the radio base station 20 or a GPS server having a network assist function using the GPS satellites.

It may be considered that the positional information of the portable radio terminal 10 is registered in the positional information server 40, and the landmark information is received by the portable radio terminal 10 together with the map image information. This example will be detailed hereinafter.

The user first operates on the keyboard 13 to obtain the positional information of the own portable radio terminal 10 by using the GPS signal processor 16, and then transmits the positional information from the portable radio terminal 10 through the communication antenna 11.

The positional information transmitted through the communication antenna 11 is received by the positional information server 40 via the radio base station 20 and the network 30.

The positional information server 40 registers the positional information therein, and transmits a file request signal to the map information server 50 for requesting part of the map image data and part of the landmark data corresponding to the positional information.

The map information server 50 responds to the request from the positional information server 40 to transmit a map information file including information of the map image and coordinates of the landmarks around the portable radio terminal 10.

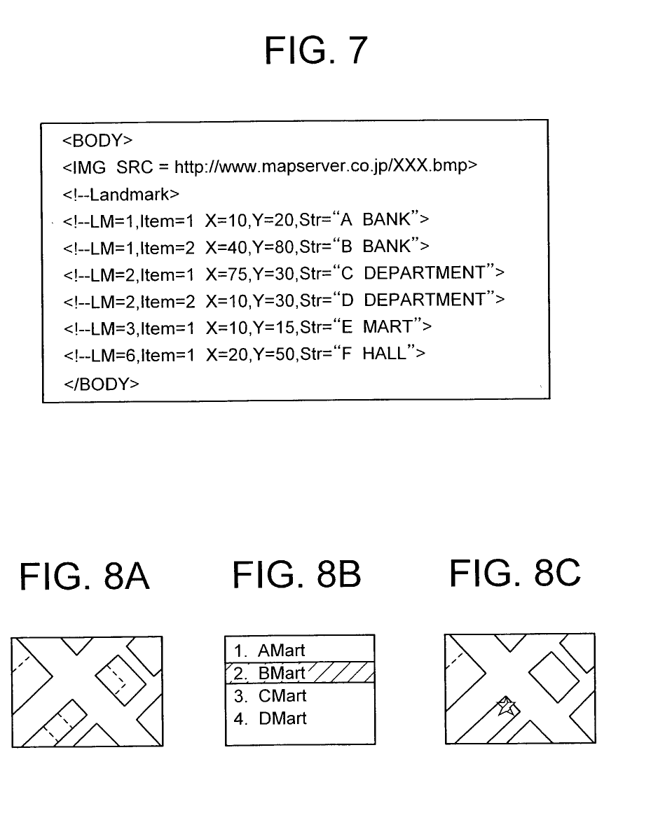

FIG. 7 shows an example of the contents of the map information file transmitted from the map information server 50.

The map information file includes information of URL of the map image and a plurality of principal species of landmarks around the position of the portable radio terminal 10. In FIG. 7, “LM1”. “LM2” and “LM3” correspond to different species of landmarks, including banks, department stores and convenience stores, “Item1” and “Item2” correspond to different stores of the same species of the landmarks, such as A bank and B bank, and X and Y correspond to X-ordinate and Y-ordinate, respectively.

The map information file transmitted from the map information server 50 is received by the portable radio terminal 10 through the positional information server 40, network 30 and radio base station 20.

After the map information file is received by the portable radio terminal, the CPU 17 allows the display unit 12 to represent the map image in the map information file on the screen.

The user then selects a species of landmarks by using a keypad in the keyboard 13, whereby the selected species of landmarks is represented by icons on the screen at the coordinates specified by the X- and Y-ordinates while being overlapped with the map image.

In the example as described above, switch of the species of the landmarks can be effected without additional transmissions and do not increase the communication costs for the portable radio terminal 10 and the load on the network.

It may be considered that some of the landmarks in a specified species in the landmark information are represented on the display unit by selecting the some of the landmarks represented in a list of the specified species of landmarks. This example will be described hereinafter.

FIGS. 8A, 8B and 8C show the map image data, list of the landmarks and the map image data including the selected landmark, respectively, in this example. In this example, the map image transmitted from the map information server 50 is represented on the display unit as shown in FIG. 8A. The user then operates on the keyboard 13 to select a species of landmarks by depressing one of the numeral keypads, thereby requesting transmission of information of the species of the landmarks.

The map information server 50 responds to the request to thereby transmit information of the species of the landmarks including a list of the landmarks. The list of the landmarks is then represented on the display unit 12. After the user selects one of the landmarks, such as “B mart” as shown in FIG. 8B, the selected landmark is represented on the screen while being overlapped with the map image, as shown in FIG. 8C.

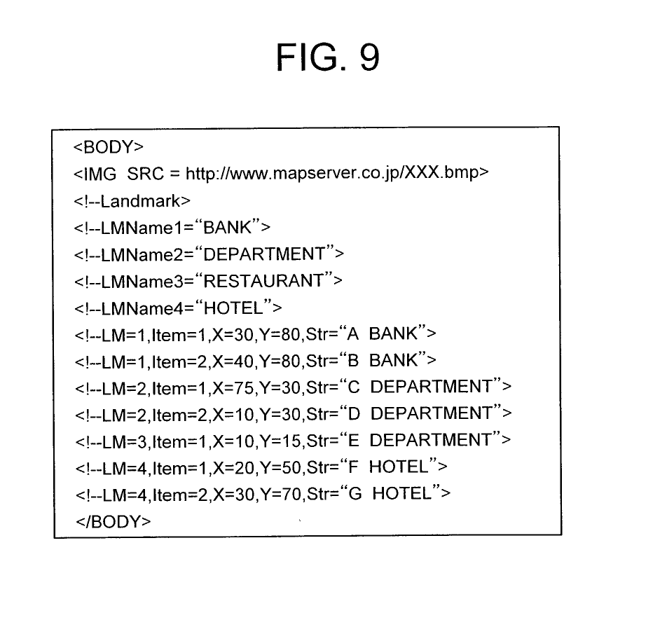

It may be considered that some of the landmarks are dynamically specified instead of allocating each species of the landmarks to a corresponding numeral keypad. This will be described with reference to FIG. 9, which shows the contents of the map information file transmitted from the map information server 50.

The map information file shown in FIG. 9 includes information of a plurality of species of landmarks, such as banks, department stores, restaurants and hotels corresponding to LMName1, LMName2, . . . , and name and coordinates of each landmark in each species. After the user specifies a desired name (LMName2) of the landmark by depressing a keypad “2” corresponding to the “LMName2” on the keyboard 13, the CPU 17 controls the display unit 12 to represent the specified landmark as an icon, which is shown as overlapped with the map image on the display unit. In this example, the landmark name is dynamically allocated to a corresponding keypad by the CPU 17, or the map information file.

Since the above embodiments are described only for examples, the present invention is not limited to the above embodiments and various modifications or alterations can be easily made therefrom by those skilled in the art without departing from the scope of the present invention.

What is claimed is:

1. A map information display system comprising a plurality of portable radio terminals each including a display unit, and at least one system server connected to said portable radio terminals via a network and storing therein map image data and landmark data, wherein each said portable radio terminal has functions for transmitting information of a position of said portable radio terminal to said system server, receiving part of said landmark data and part of said map image data corresponding to said position of said portable radio terminal from said system server, and allowing said display unit to selectively represent icons of landmarks specified by said part of said landmark data overlapped with a map image specified by said part of said map image data.

2. The map information display system according to claim 1, wherein said display unit represents a list of said landmarks specified by said landmark data to allow a user to select at least one of said landmarks in said list, and represents icons of said at least one of said landmarks selected in said list.

3. The map information display system according to claim 1, wherein each portable radio terminal receives said part of said landmark data separately from said part of said map image data.

4. The map information display system according to claim 1, wherein each said portable radio terminal receives said part of said land mark data and said part of said map image data in a single file.

5. The map information display system according to claim 1, wherein each said portable radio terminal mounts thereon a keyboard including a plurality of keypads, and one of said keypads corresponds to one of a plurality of species of said landmarks.

6. The map information display system according to claim 1, wherein said landmark data includes information of a plurality of species of landmarks, coordinates of each of said landmarks, and a name of each of said landmarks.

7. The map information display system according to claim 1, wherein each said portable radio terminal mounts thereon a keyboard including a plurality of keypads, and one of said keypads is dynamically allocated to one of a plurality of species of said landmarks by said landmark data.

8. The map information display system according to claim 1, wherein said at least one system server includes a map information server storing therein said map image data and said landmark data, and a positional information server receiving information of said position of said portable radio terminal and requesting said map information server to transmit said part of said map image data and said part of said landmark data based on said information of said position of said portable radio terminal.

9. A portable radio terminal comprising:
a communication block for receiving part of map image data and part of landmark data via a network from a server connected to said communication block, said part of map image data and said part of landmark data corresponding to a position of said portable radio terminal;
a display unit for representing a map image specified by said part of said map image data; and
a control unit for controlling said display unit to selectively represent landmarks specified by said part of said landmark data, said landmarks being overlapped with said map image on said display unit.

10. The portable radio terminal according to claim 9, wherein said display unit represents a list of said landmarks specified by said landmark data to allow a user to select at least one of said landmarks in said list, and represents icons of said at least one of said landmarks selected in said list.

11. The portable radio terminal according to claim 9, wherein said communication block receives said part of said landmark data separately from said part of said map image data.

12. The portable radio terminal according to claim 9, wherein said communication block receives said part of said land mark data and said part of said map image data in a single file.

13. The portable radio terminal according to claim 9, wherein said portable radio terminal mounts thereon a keyboard including a plurality of keypads, and one of said keypads corresponds to one of a plurality of species of said landmarks.

14. The portable radio terminal according to claim 9, wherein said landmark data includes information of a plurality of species of landmarks, coordinates of each of said landmarks, and a name of each of said landmarks.

15. The portable radio terminal according to claim 9, wherein said portable radio terminal mounts thereon a keyboard including a plurality of keypads, and one of said keypads is dynamically allocated to one of a plurality of species of said landmarks by said landmark data.

16. The portable radio terminal according to claim 9, further comprising a GPS signal processor for determining said position of said portable radio terminal.

17. A method for supplying map information to a portable radio terminal comprising:
storing separately map image data and landmark data, said landmark data including information of a plurality of species of landmarks, coordinates of each of said landmarks, and a name of each of said landmarks:
specifying part of said map image data and part of said landmark data based information of a position of the portable radio terminal received therefrom; and
transmitting said specified part of said map image data and said specified part of said landmark data in a format to allow a display unit of the portable radio terminal to selectively represent icons of landmarks specified by said part of said landmark data while being overlapped with a map image specified by said part of said map image data.
